(19) United States
(12) Patent Application Publication
(10) Pub. No.: US 2011/0074738 A1
(43) Pub. Date: Mar. 31, 2011

(54) Touch Detection Sensing Apparatus

(75) Inventors: Xinlin Ye, Beijing (CN); Jianjun Liu, Beijing (CN); Xinbin Liu, Beijing (CN)

(73) Assignee: Beijing Irtouch Systems Co., Ltd., Beijing (CN)

(21) Appl. No.: 12/922,079

(22) PCT Filed: May 19, 2009
(86) PCT No.: PCT/CN09/71848

§ 371 Date: Sep. 10, 2010

(30) Foreign Application Priority Data
Jun. 18, 2008 (CN) 200810115165.8
Mar. 6, 2009 (CN) 200920105749.7

(51) Int. Cl. G06F 3/042

(52) U.S. Cl. 345/175

(57) ABSTRACT

A touch detection sensing apparatus is disclosed, which comprises: at least one image capturing device, at least one reflection mirror and an image processing circuit. The at least one image capturing device is used to capture an image of a touch object in a detected screen and an image of a virtual image of the touch object in the at least one reflection mirror. The image processing circuit can calculate a position of the touch object based on the image of the touch object and the image of the virtual image of the touch object in a reflection mirror captured by an image capturing device.

### TECHNICAL FIELD OF THE INVENTION

The present invention relates to a touch detection sensing apparatus, more particularly, to a touch detection sensing apparatus including an image capturing device and a reflection mirror.

### BACKGROUND OF THE INVENTION

Currently, an image capturing device (camera) is used as a device for detecting a touch object on a touch screen. Generally, it uses two cameras disposed at corners of a detected screen to detect the touch object by means of Triangulation. This solution has the advantage of good applicability. However, for the solution that position coordinates of the touch object is obtained by image processing, it is necessary to use two cameras to obtain data required by the Triangulation, on the other hand, it requires high performance of a microprocessor for processing the images of the cameras. Thus production cost of such device is increased. The U.S. Pat. No. 7,274,356 discloses an apparatus in which a touch object is detected and located by a camera and two reflection mirrors that are disposed at an inner side of edges of a detected screen. In this solution, only one camera is used. However, two reflection mirrors are needed, and the two reflection mirrors should be disposed on the adjacent edges and an intersection of the two reflection mirrors form a non-reflection area. Therefore the structure of the apparatus is still complicated, which makes manufacture and installation of the apparatus difficult.

In addition, a field angle of the image capturing device (camera) in the touch detection sensing apparatus in the prior art is generally very large, and the field angle of each image capturing device can cover the whole detected screen. So the camera with a large field angle will have large distortion. Therefore, there exists the problem of large distortion and large location error in these touch detection sensing apparatuses.

### SUMMARY OF THE INVENTION

According to an aspect of the present invention, there is provided a touch detection sensing apparatus for detecting a position of a touch object on a detected screen, which has a simplified structure and comprises: a detected screen; an reflection mirror, which enables the detected screen to be imaged as a virtual image in the reflection mirror; an image capturing device, for capturing an image of the touch object on the detected screen and capturing an image of the virtual image of the touch object in the reflection mirror, wherein field of view of the image capturing device covers the whole detected screen and the whole image of the detected screen in the reflection mirror. The touch detection sensing apparatus further comprises: an image processing circuit for calculating the position of the touch object on the detected screen based on the image of the touch object and the image of the virtual image of the touch object in the reflection mirror captured by the image capturing device.

According to another aspect of the present invention, there is provided a touch detection sensing apparatus for detecting a position of a touch object on a detected screen, in order to reduce the distortion of an image capturing device and improve location accuracy of the apparatus, which comprises: a detected screen; two image capturing devices; and a reflection mirror; wherein each image capturing device has a small field angle so that its field of view does not cover the whole detected screen, and an overlapping of the fields of view of two image capturing devices, i.e. the total field of view of the two image capturing devices, covers the whole detected screen. The touch detection sensing apparatus further comprises an image processing circuit, wherein when the touch object appears in a common field of view of the two image capturing devices, the image processing circuit calculates the position of the touch object in the detected screen based on the images of the touch object captured by the two image capturing devices by using Triangulation; when the touch object appears in the field of view covered only by one image capturing device, the image processing circuit calculates the position of the touch object in the detected screen based on the image of the touch object and the image of the virtual image of the touch object in the reflection mirror captured by the one image capturing device.

### BRIEF DESCRIPTION OF THE DRAWINGS

FIG. 1a is a structure diagram of a touch detection sensing apparatus and its coordinate detection schematic diagram according to an embodiment of the present invention;

FIG. 1b is a schematic perspective view of the touch detection sensing apparatus shown in FIG. 1a;

FIG. 2 is another structure diagram of a touch detection sensing apparatus equivalent to FIG. 1 and its coordinate detection schematic diagram;

FIG. 3 is a structure diagram of a touch detection sensing apparatus including two image capturing devices according to another embodiment of the present invention;

FIG. 4 is a structure diagram of an infrared light source comprising a plurality of light-emitting tubes;

FIG. 5 is a structure diagram of an infrared light source comprising a light-emitting tube and a concave lens;

FIG. 6 is a structure diagram of a touch detection sensing apparatus including two image capturing devices and two reflection mirrors according to another embodiment of the present invention;

FIG. 7 is a structure diagram of a touch detection sensing apparatus including two image capturing devices and two reflection mirrors according to another embodiment of the invention; and

FIG. 8 is a diagram of imaging a touch object and a virtual image of the touch object in a reflection mirror on a photosensitive chip of the image capturing device.

In the drawings, the same component or element is denoted by the same reference number, wherein the meanings of every reference number are:

101: detected screen; 102: camera (image capturing device); 103: reflection mirror with a strip shape; 104: touch object; 105: virtual image of the touch object in reflection mirror; 106: infrared light source; 107: light directly from touch object to a vertex of the field angle θ of camera; 108: light to the vertex of the field angle θ of camera reflected by reflection mirror and surface of touch object; 109: virtual light of image in reflection mirror; 110: reflection surface of reflection mirror; 111: frame of detected screen; 112 to 115: four edges of frame 111 of detected screen; 401: motherboard for installing infrared light-emitting tube; 402: infrared light-emitting tube; 501: single infrared light-emitting tube; 502: concave lens; 601: effective pixel band of photosensitive chip in camera; 602: a part of image of light directly irradiating touch object on photosensitive chip; 603: image of virtual image of touch object reflected by reflection mirror on photosensitive chip.

### DETAILED DESCRIPTION OF THE PREFERRED EMBODIMENTS

Next, the embodiments of the present invention will be described in detail by way of example in conjunction with accompany drawings.

### First Embodiment

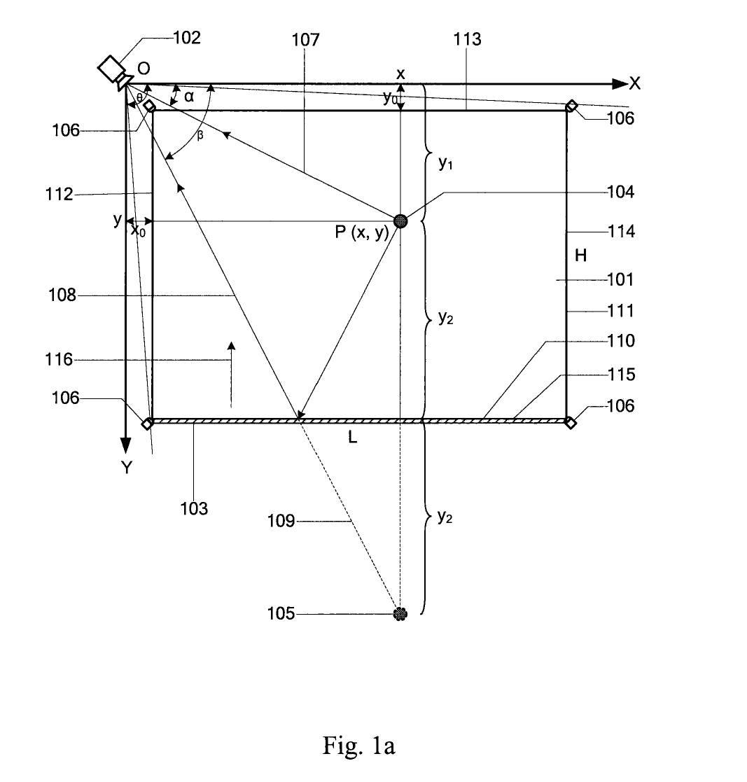

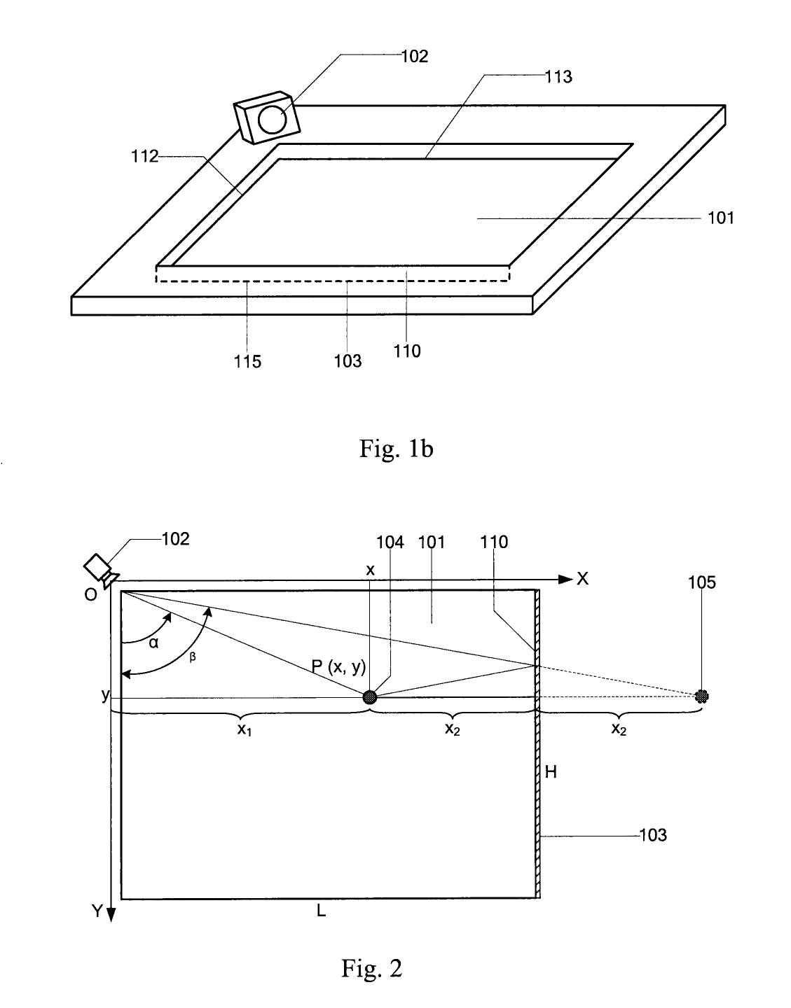

FIGS. 1a and 1b show a structure diagram of a touch detection sensing apparatus according to an embodiment of the invention and a schematic diagram of performing coordinate detection respectively. In the embodiments shown in FIGS. 1a and 1b, the detected screen 101 is a touch area of a touch screen, that is, the detected screen 101 is an area of the touch screen for a user to perform touch operation. The image capturing device is a camera 102 which is installed (or disposed) at a corner of a surface of the detected screen 101. In this embodiment, two edges forming the corner are two adjacent edges 112 and 113 of the detected screen 101. The reflection mirror 103 is disposed on an edge (i.e. the edge 115) opposite to one edge (i.e. the edge 113) of the two edges. The length of the reflection mirror 103 at least equals to the length of the edge 115. A reflection surface 110 of the reflection mirror 103 is towards the edge 113 opposite to the edge 115 where the reflection mirror 103 is located, i.e. towards an area within the frame 111. That is to say, in FIG. 1a, the reflection surface 110 of the reflection mirror 103 is towards the direction indicated by the arrow 116. The image processing circuit (not shown) is coupled to the camera 102 to obtain the image data captured by the camera 102.

FIG. 1a also shows a coordinate system XOY, wherein the X axis and Y axis are in parallel with the edge 113 and 112 of the detected screen respectively, and the origin is the vertex of the field angle θ of the camera 102, i.e. the central point of the lens equivalent to the objective lens of the camera 102. Assume that there is a touch object 104 on the detected screen, its coordinate value in the coordinate system XOY is set as P(x, y), the horizontal length of the edges of the detected screen is set as L (i.e. the length of the edges 113, 115), and the height is set as H. According to optical reflection theory and analytic geometry theory, the following formulas can be obtained:

y₁=xtgα

2y₂+y₁=xtgβ

y₁+y₂=H+y₀

In the above formulas, y₀ is a distance from an edge of the detected screen opposite to the reflection mirror to the coordinate axis in parallel with the reflection mirror, in FIG. 1a, y₀ is the distance between the upper edge 113 of the detected screen and X axis; α is an angle between the light 107 reflected directly from the surface of the touch object 104 to the vertex of the field angle θ of the camera and X axis; β is an angle between the light 108 reflected from the touch object to the vertex of the field angle θ of the camera by the reflection mirror and X axis. It can be known from the optical theory of photography or camera that the angles α and β can be obtained by detecting the position of the image of the touch object on a photosensitive chip in the camera and by utilizing the position where the virtual light 109 emitted by the virtual image 105 is imaged in the photosensitive chip in the camera. Thus, the three unknown numbers x, y1 and y2 (wherein y1=y) can be calculated by solving a three-variable linear equations that comprises the above three formulas. Additionally, in FIG. 1a, x0 is a distance between an edge 112 of the detected screen and Y axis, and x0 and y0 may be zero or a value that is small but bigger than zero. x0 and y0 are the distance parameters between the detected screen 101 and the camera 102, and are known, so the coordinate value of the touch object 104 in the detected screen can be acquired. Here, the touch object 104 is approximately a point.

A person skilled in the art can appreciate that the expressions “installed at a corner” or “disposed at a corner” can be interpreted as installed or disposed at somewhere adjacent to the corner, i.e. x0 and y0 are zero or are a positive value that is small but bigger than zero.

FIG. 2 shows a variation of the first embodiment. It differs from FIG. 1 in that the reflection mirror 103 is installed on the edge 114 instead of on the edge 115. The principle of detecting and solving the coordinate value is same as that of FIG. 1, and is not described here.

### Second Embodiment

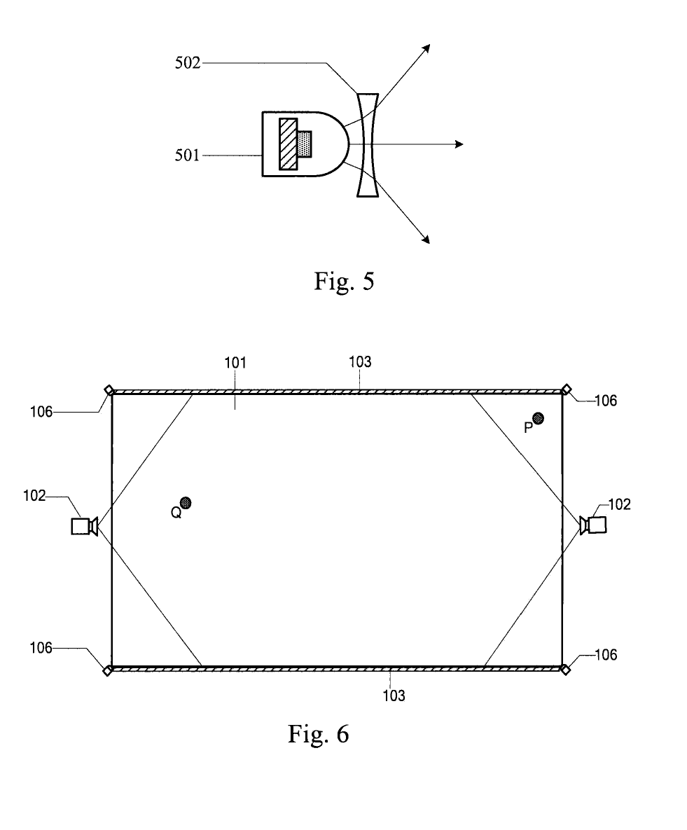

To accommodate various complex illumination environments and display contents, based on the first embodiment, an infrared light source, such as the infrared light source 106 in FIG. 1a, can be disposed on the edges of detected screen, wherein luminous surface of the infrared light source is towards the detected screen, i.e. towards the area within the frame. The image capturing device is photosensitive to the infrared light. The infrared light source is used here as the infrared light is invisible for human eyes. If the infrared light source is only used for illumination, an infrared color filter (not shown) can be added on a light path of the camera so that the infrared light can transmit, thereby eliminating interference from ambient light. As shown in FIG. 1a, four infrared light sources are disposed on the frame 111 of the detected screen 101, such as at four corners. There are two kinds of structure for the infrared light source. The first is, as shown in FIG. 4, that each infrared light source comprises a plurality of infrared light-emitting tubes 402 arranged in parallel, typically, they are installed on a motherboard 401 in a sector to get a large illumination scattering angle. The second is, as shown in FIG. 5, that each infrared light source comprises one infrared light-emitting tube 501 and, if necessary, a concave lens 502 is disposed in front of the luminous surface of the infrared light-emitting tube to enlarge the scattering angle of the infrared light-emitting tube to obtain the uniform light.

In addition, the above infrared light source can be replaced with other light sources.

### Third Embodiment

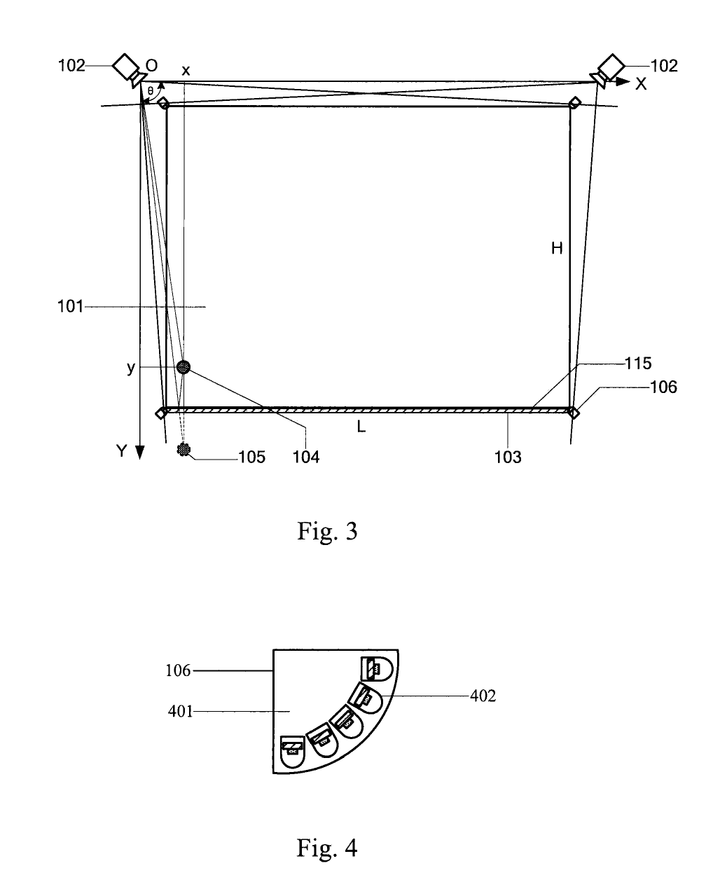

In the structure shown in FIG. 1a, if the field angle θ of the camera is small, the distance between the camera and the screen is required to be large to ensure the whole detected screen is within the field of view of the camera. This will increase installation size of the system, but can obtain the uniform location accuracy on the whole screen. If the camera is required to be close to the detected screen to reduce the installation size, the field angle θ of the camera is approaching or even larger than 90 degrees. It can be known from FIGS. 3 and 1a that when the touch object is very close to the vertical edge at the left side, the angles α and β are very close, so when the angles change a little, their tangent value will vary significantly, at this time, the distortion of lens of the camera will also be very large, thus it is not easy to get a good detection accuracy. In order to get better and uniform detection accuracy, based on the first or second embodiment, another camera 102 is added at the corner adjacent to the camera 102, as shown in FIG. 3. Now the reflection mirror 103 is disposed on the edge opposite to the edge of the detected screen between the two cameras, that is, the reflection mirror is disposed on the edge 115 which is not the edge forming the corner where the cameras are disposed. With this structure, it is easy to get the uniform detection accuracy on the whole screen by setting each camera to work in its own optimal accuracy. That is, in FIG. 3, the field angle of each camera covers the whole detected screen, but the image processing circuit only utilize the image of the touch object and the image of the virtual image of the touch object in the reflection mirror captured within a part of field of view of each camera to calculate the position of the touch object, so as to prevent the calculation error from being too large and avoid inaccuracy in the position when the angles α and β are close to 90 degrees. The part of field of view of each camera utilized by the image processing circuit when calculating the position of the touch object is referred to as an effective field of view.

As a variation of the embodiment, it is not necessary for each camera to have a large field angle. The field of view of each camera may only cover a portion of the detected screen, but the overlapping of the fields of view of the two cameras would cover the whole detected screen. When the touch object appears in a common field of view of the two image capturing devices, the image processing circuit calculates the position of the touch object on the detected screen based on the image of the touch object captured by the two image capturing devices by using the known Triangulation. When the touch object appears in the field of view covered only by one image capturing device, similar to the first embodiment, the image processing circuit calculates the position of the touch object in the detected screen based on the image of the touch object and the image of the virtual image of the touch object in the reflection mirror captured by the one image capturing device. In this way, the problem of high image distortion can be overcome and the location accuracy on the whole screen can be improved, because each image capturing device has a relatively small field angle.

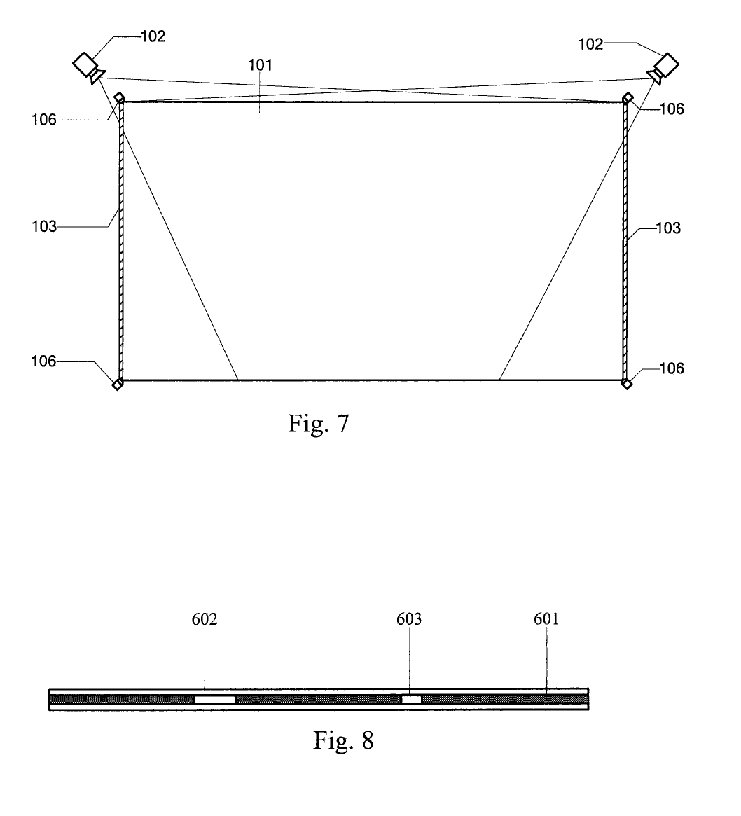

In this embodiment, the field angle or effective field angle of each image capturing device can be set as shown in FIG. 7.

### Fourth Embodiment

FIG. 6 is a structure diagram of a touch detection sensing apparatus according to another embodiment of the present invention. The touch detection sensing apparatus is used to detect the position of the touch object on a rectangular detected screen 101, and comprises the detected screen 101, two cameras 102, the image processing circuit, and two reflection mirrors 103, and optionally, the infrared light sources 106. The length of each of the reflection mirrors 103 at least equals to the length of the corresponding edge of the rectangular detected screen 101. The two cameras 102 are disposed on two opposite short edges of the detected screen 101 respectively, that is to say, the field of view of each of the two image capturing devices (cameras 102) does not cover the whole detected screen 101, but the whole detected screen 101 is within the total field of view of the two cameras 102, that is, a portion of the detected screen 101 is within both fields of view of the two cameras 102, and other portions are within the respective fields of view of the two cameras 102. The two reflection mirrors 103 are installed on two opposite edges adjacent to the edges where the cameras 102 are disposed respectively, and the reflection surfaces of the reflection mirrors 103 are towards the detected screen 101, i.e., in this embodiment, the reflection mirrors 103 are disposed on two opposite long edges of the detected screen 101 respectively.

As shown in FIG. 6, when the touch object may be within the both fields of view of the two cameras, as the touch object Q shown in FIG. 6, the image processing circuit can calculate the position of the touch object by using the known Triangulation.

In another case where the touch object is only within the field of view of one camera, as the touch object P shown in FIG. 6, the position of the touch object is calculated by using the same method as the first embodiment, that is, the image processing circuit calculates the position of the touch object based on the image of the touch object P and the image of the virtual image of the touch object P in the upper reflection mirror 103 captured by the left camera 102.

Obviously, when the touch object is only within the field of view of one camera and is close to the lower reflection mirror, the image processing circuit calculates the position of the touch object based on the image of the touch object P and the image of the virtual image of the touch object P in the lower reflection mirror 103 captured by the camera 102.

As a variation of the embodiment, the positions of the image capturing devices are not changed, and the reflection mirrors can be disposed on the two edges where the image capturing devices are disposed, that is, the reflection mirrors and the image capturing devices are disposed on the same edges of the detected screen.

### Fifth Embodiment

FIG. 7 illustrates a structure diagram of a touch detection sensing apparatus according to another embodiment. As shown in FIG. 7, the touch detection sensing apparatus differs from the touch detection sensing apparatus in the fourth embodiment shown in FIG. 6 in that the installation position of the image capturing devices and reflection mirrors is different. In FIG. 7, two image capturing devices (cameras 102) are disposed at two adjacent corners of the detected screen 101, and two reflection mirrors 103 are disposed on two opposite edges that are not common for the two adjacent corners where cameras 103 are disposed.

When the touch object is within the both fields of view of the two cameras, the image processing circuit can calculate the position of the touch object by using the known Triangulation. When the touch object is only within the field of view of one camera, the position of the touch object is calculated by using the same method as the first embodiment.

In comparison with the fourth embodiment, this embodiment can greatly reduce the field angle of the image capturing device, thereby obtaining the smaller distortion and further improving the location accuracy for the touch object.

### Other Variations

Since the touch detection sensing apparatus is used to detect whether there is the touch object in proximity to the surface of the detected screen, in the above embodiments, the system only needs the image data of a narrow strip on the photosensitive chip inside the camera. As shown in FIG. 8, the angles α and β can be calculated only by selecting a line array 601 formed by pixels on the photosensitive chip with surface array structure and detecting the positions of the image 602 formed by directly illuminating the touch object and the image 603 formed by the reflection of the reflection mirror on the line array. Thus, in the above embodiments, the surface array photosensitive chip inside the camera can be replaced by a photosensitive chip with line array structure.

In addition, the detected screen 101 may also be in other shapes. In the case where the two reflection mirrors are installed in opposite to each other, the two image capturing devices may also be disposed on different planes in parallel with the detected screen 101. The negative effects due to the opposite installation of two reflection mirrors with the surfaces opposite to each other can be reduced. The image capturing device in the above embodiments is the camera, but it can be replaced with other image capturing devices to capture the image of the touch object.

The touch detection sensing apparatus described in the above embodiments may be disposed on a plasma television monitor or a computer monitor, or disposed in front of or behind a projection screen of a projector, or integrated into a touch screen, or used in other touch systems.

The embodiments of the present invention are described above only by way of example. The present invention is not limited to the specific details and the illustrative embodiments disclosed herein in its broader aspects. Therefore, various variations can be derived without departing from the spirit and scope of the general inventive concept and its equivalent description, which is defined by the appended claims.

1. A touch detection sensing apparatus for detecting a position of a touch object on a detected screen, comprising:
at least one reflection mirror, wherein a reflection surface of each reflection mirror is towards the detected screen, such that the detected screen can be imaged as a virtual image in the at least one reflection mirror;
at least one image capturing device for capturing an image of the touch object on the detected screen and capturing an image of the virtual image of the touch object in the reflection mirror, wherein an overlapping of respective field of view of the at least one image capturing device covers the whole detected screen; and
an image processing circuit that receives image data captured by the at least one image capturing device and calculates the position of the touch object on the detected screen based on the image of the touch object and the image of the virtual image of the touch object in a reflection mirror captured by the image capturing device.

2. The touch detection sensing apparatus of claim 1, which only comprises one image capturing device and one reflection mirror, the field of view of the image capturing device covers the whole detected screen and the whole image of the detected screen in the reflection mirror.

3. The touch detection sensing apparatus of claim 2, wherein the detected screen is of a rectangle shape, and wherein the reflection mirror is of a strip shape which extends along one edge of the rectangle longitudinally, and a longitudinal length of the reflection mirror at least equals to that of the one edge of the rectangle.

4. The touch detection sensing apparatus of claim 3, wherein the image capturing device is disposed at a corner of the rectangle, and the reflection mirror is located on an edge opposite to one of the two edges forming the corner.

5. The touch detection sensing apparatus of claim 1, which comprises two image capturing devices and one reflection mirror, wherein the field of view or effective field of view of each image capturing device only covers a portion of the detected screen, and the overlapping of the fields of view or effective fields of view of the two image capturing devices covers the whole detected screen,
when the touch object appears in the common field of view or effective field of view of the two image capturing devices, the image processing circuit calculates the position of the touch object on the detected screen based on the image of the touch object captured by the two image capturing devices;
when the touch object appears in the field of view or effective field of view covered only by one image capturing device, the image processing circuit calculates the position of the touch object in the detected screen based on the image of the touch object and the image of the virtual image of the touch object in the reflection mirror captured by the one image capturing device.

6. The touch detection sensing apparatus of claim 5, wherein the detected screen is of a rectangle shape, and wherein the reflection mirror is of a strip shape which extends along one edge of the rectangle longitudinally, and a longitudinal length of the reflection mirror equals to that of the one edge of the rectangle.

7. The touch detection sensing apparatus of claim 6, wherein the two image capturing devices are disposed at two corners of the rectangle respectively, and the reflection mirror is installed on an edge which is not the edges forming the corner where the image capturing device is disposed.

8. The touch detection sensing apparatus of claim 6, wherein the edge where the reflection mirror is located is a long edge of the rectangle.

9. The touch detection sensing apparatus of claim 1, which comprises two image capturing devices and two reflection mirrors, wherein the field of view of each image capturing device does not cover the whole detected screen, the overlapping of the fields of view of the two image capturing devices covers the whole detected screen.

10. The touch detection sensing apparatus of claim 9, wherein the detected screen is of a rectangle shape, and wherein both reflection mirrors are of a strip shape and are disposed on two opposite edges of the rectangle respectively and extend along the two edges, a length of each reflection mirror at least equals to a length of the corresponding edge.

11. The touch detection sensing apparatus of claim 10, wherein when the touch object appears in the common field of view of the two image capturing devices, the image processing circuit calculates the position of the touch object on the detected screen based on the image of the touch object captured by the two image capturing devices;
when the touch object appears in the field of view covered only by one image capturing device, the image processing circuit calculates the position of the touch object on the detected screen based on the image of the touch object and the image of the virtual image of the touch object in a reflection mirror captured by the one image capturing device.

12. The touch detection sensing apparatus of claim 11, wherein the two image capturing devices are disposed at two adjacent corners of the rectangle respectively, and wherein the two reflection mirrors are installed on two opposite edges that are not common for the two corners where the image capturing devices are disposed.

13. The touch detection sensing apparatus of claim 12, wherein the reflection mirrors are disposed on short edges of the rectangle.

14. The touch detection sensing apparatus of claim 11, wherein the two reflection mirrors are disposed on the long edges of the rectangle, and wherein the two image capturing devices are disposed on two edges adjacent to the edges of the rectangle where the two reflection mirrors are installed respectively.

15. The touch detection sensing apparatus of claim 1, wherein when the image processing circuit calculates the position of the touch object on the detected screen based on the image of the touch object and the image of the virtual image of the touch object in a reflection mirror captured by an image capturing device, the image processing circuit uses the following formulas:
y₁=xtgα
2y₂+y₁=xtgβ
y₁+y₂=H+y₀
wherein an origin of a coordinate system used by the above formulas is a vertex of field angle of the image capturing device, two coordinate axes are parallel to two adjacent edges of the rectangular detected screen respectively;
angle α is an angle between a line from the touch object to the vertex of the field angle of the image capturing device and the coordinate axis in parallel with the reflection mirror;
angle β is an angle between a line from the virtual image of the touch object in the reflection mirror to the vertex of the field angle of the image capturing device and the coordinate axis in parallel with the reflection mirror;
y₀ is a distance from an edge of the detected screen opposite to the reflection mirror to the coordinate axis in parallel with the reflection mirror;
y₁ is a distance from the touch object to the coordinate axis in parallel with the reflection mirror;
y₂ is a distance from the touch object to the reflection mirror.

16. The touch detection sensing apparatus of claim 1, wherein the image capturing device is a camera.

17. The touch detection sensing apparatus of claim 16, wherein a photoelectric sensor chip in the camera is a line array photosensitive chip.

18. The touch detection sensing apparatus of claim 6, wherein the two image capturing devices are disposed on different planes in parallel with the detected screen respectively.

19. The touch detection sensing apparatus of claim 1, wherein at least one infrared light source is disposed on an edge of the detected screen, so as to emit infrared light toward the detected area.

20. The touch detection sensing apparatus of claim 19, wherein four infrared light sources are disposed so as to illuminate the detected screen from four directions.

21. The touch detection sensing apparatus of claim 19, wherein each of the infrared light sources comprises an infrared light-emitting tube.

22. The touch detection sensing apparatus of claim 21, wherein a concave lens is disposed in front of each of the infrared light sources.

23. The touch detection sensing apparatus of claim 19, wherein each of the infrared light sources comprises a plurality of infrared light-emitting tubes arranged in a sector.

24. The touch detection sensing apparatus of claim 19, wherein an infrared color filter is disposed on an optical path before each of the image capturing devices.

25. The touch detection sensing apparatus of claim 1, wherein the detected screen is a touch area of a touch screen.

26. The touch detection sensing apparatus of claim 11, wherein the two image capturing devices are disposed on different planes in parallel with the detected screen respectively.
